(19) United States
(12) Patent Application Publication
(10) Pub. No.: US 2020/0226516 A1
(43) Pub. Date: Jul. 16, 2020

(54) INFORMATION PROCESSING METHOD AND INFORMATION PROCESSING SYSTEM

(71) Applicant: PANASONIC INTELLECTUAL PROPERTY CORPORATION OF AMERICA, Torrance, CA (US)

(72) Inventors: Hirokazu KITO, Osaka (JP); Atsuko OONO, Tokyo (JP); Yoshimi NISHII, Kyoto (JP); Mitsuhiro ASO, Osaka (JP); Akinori OZEKI, Kanagawa (JP)

(73) Assignee: PANASONIC INTELLECTUAL PROPERTY CORPORATION OF AMERICA, Torrance, CA (US)

(21) Appl. No.: 16/830,851

(22) Filed: Mar. 26, 2020

Related U.S. Application Data
(62) Division of application No. 15/723,234, filed on Oct. 3, 2017.
(60) Provisional application No. 62/414,120, filed on Oct. 28, 2016.

(30) Foreign Application Priority Data
Jun. 28, 2017 (JP) 2017-126162

(51) Int. Cl. G06Q 10/06; G06F 3/0482; G06Q 50/12

(52) U.S. Cl. CPC G06Q 10/06312; G06F 3/04847; G06Q 50/12; G06F 3/0482

(57) ABSTRACT

A method and system render a processor able to determine a sectioning position for sectioning a cuisine preparation process after the processor is initially unable to determine the sectioning position for sectioning the cuisine preparation processes into a) a pre-preservation process of steps preparing and preserving an ingredient using a predetermined preservation process that is no longer than its predetermined preservation period after which its quality deteriorates, and b) a finishing process performed no later than the end of the predetermined preservation period. A screen displays an area for receiving an instruction to switch the time for performing the finishing process, in response to the processor being rendered unable to section the cuisine preparation process into separately displayed pre-preservation steps and finishing steps when the input time at which the finishing process is to be performed is later than the end of the predetermined preservation period.

### CROSS REFERENCE TO RELATED APPLICATION

This application is a divisional application of U.S. application Ser. No. 15/723,234, filed Oct. 3, 2017, which claims priority from provisional application No. 62/414,120, filed Oct. 28, 2016, and which claims the foreign priority benefit of JP 2017-126162, filed Jun. 28, 2017. The entire disclosures of all of the above-identified applications are expressly incorporated herein by reference in their entirety.

### BACKGROUND

### 1. Technical Field

The present disclosure relates to an information processing method and information processing system.

### 2. Description of the Related Art

There conventionally has been a food preparation method where an intermediate ingredient that has been prepared partway through a food preparation process for a cuisine is preserved by refrigeration or freezing, and the food preparation is resumed on a later day. There has been disclosed a food preparation support device that appropriately presents information regarding at which food preparation process out of the entire food preparation process the intermediate ingredient is to be preserved by freezing, in this food preparation method (see Japanese Unexamined Patent Application Publication No. 2009-187338).

The food preparation process up to creating the intermediate ingredient that is preserved by refrigeration or freezing is also referred to as a “pre-preparation process”, and a food preparation process of completing the cuisine from the intermediate ingredient is also referred to as a “finishing process”. The cuisine that has been completed by the finishing process is expected to be provided for consumption within a few hours of completion.

However, out of the entire food preparation process, the food preparation process of saving the intermediate ingredient is set beforehand in the technology disclosed in Japanese Unexamined Patent Application Publication No. 2009-187338. Accordingly, there is an inconvenience that, if the user is not able to secure enough time to perform up to the food preparation process that has been set beforehand, the above food preparation method cannot be executed. If the user makes an independent judgement regarding at which food preparation process out of the entire food preparation process the intermediate ingredient is to be preserved, there is no guarantee that the completed cuisine will have high quality. In this way, there is a problem that the quality of the cuisine may deteriorate in a case where time is limited for the user to execute food preparation processes (i.e., the pre-preparation process or finishing process).

### SUMMARY

One non-limiting and exemplary embodiment provides an information processing method that suppresses deterioration in quality of cuisine, even in a case where time is limited for the user to execute food preparation processes.

In one general aspect, the techniques disclosed here feature an information processing method according to an aspect of the present disclosure include: acquiring cuisine data for a cuisine that is prepared over a plurality of food preparation processes using a processor, the cuisine data including necessary time that is required for each of the plurality of food preparation processes; accepting request information for sectioning the plurality of food preparation processes into a pre-preparation process and a finishing process using the processor, the request information indicating a request for at least one of an amount of time that a user will take on the pre-preparation process and an amount of time that the user will take on the finishing process; deciding a sectioning position to section the plurality of food preparation processes into the pre-preparation process and the finishing process satisfying the request information using the processor, based on the necessary time included in the cuisine data; and displaying at least one of the pre-preparation process and the finishing process sectioned by the decided sectioning position on a display using the processor.

The information processing method according to the present disclosure can suppress deterioration in quality of cuisine, even in a case where time is limited for the user to execute food preparation processes.

It should be noted that general or specific embodiments may be implemented as a system; a method; an integrated circuit, a computer program, or a storage medium such as a computer-readable Compact Disc-Read Only Memory (CD-ROM) or the like, or any selective combination of a system, method, integrated circuit, computer program, and storage medium.

Additional benefits and advantages of the disclosed embodiments will become apparent from the specification and drawings. The benefits and/or advantages may be individually obtained by the various embodiments and features of the specification and drawings, which need not all be provided in order to obtain one or ore of such benefits and/or advantages.

### BRIEF DESCRIPTION OF THE DRAWINGS

FIG. 1 is a schematic diagram illustrating an example of the overall configuration of an information processing system according to a first embodiment;

FIG. 2 is a block diagram illustrating the functional configuration of an information processing system according to the first embodiment;

FIG. 3 is a block diagram illustrating an example of a hardware configuration of a server according to the first embodiment;

FIG. 4 is a block diagram illustrating an example of a hardware configuration of a terminal according to the first embodiment;

FIG. 5 is an explanatory diagram illustrating a first example of cuisine data according to the first embodiment;

FIG. 6 is an explanatory diagram illustrating a second example of cuisine data according to the first embodiment;

FIG. 7 is an explanatory diagram of sectioning positions according to the first embodiment;

FIG. 8 is a flowchart illustrating processing of the information processing system according to the first embodiment;

FIG. 9 is a flowchart illustrating processing for deciding and outputting a sectioning position in the information processing system according to the first embodiment;

FIG. 10 is an explanatory diagram illustrating a first example of sectioning position deciding processing according to the first embodiment;

FIG. 11 is an explanatory diagram illustrating a second example of sectioning position deciding processing according to the first embodiment;

FIG. 12 is an explanatory diagram illustrating a first example of food preparation processes that the information processing system according to the first embodiment presents;

FIG. 13 is an explanatory diagram illustrating a second example of food preparation processes that the information processing system according to the first embodiment presents;

FIG. 14 is an explanatory diagram illustrating a third example of food preparation processes that the information processing system according to the first embodiment presents;

FIG. 15 is an explanatory diagram illustrating a fourth example of food preparation processes that the information processing system according to the first embodiment presents;

FIG. 16 is an explanatory diagram illustrating processing of adding processes in information processing system according to the first embodiment;

FIG. 17 is an explanatory diagram illustrating a first example of an image, indicating notification to the user, which the information processing system according to the first embodiment presents;

FIG. 18 is an explanatory diagram illustrating a second example of an image, indicating notification to the user; which the information processing system according to the first embodiment presents;

FIG. 19 is an explanatory diagram illustrating a third example of an image, indicating notification to the user, which the information processing system according to the first embodiment presents;

FIG. 20 is an explanatory diagram illustrating a first deciding method of sectioning positions, by a deciding unit according to a second embodiment;

FIG. 21 is an explanatory diagram illustrating a second deciding method of sectioning positions, by a deciding unit according to the second embodiment;

FIG. 22 is an explanatory diagram illustrating an example of an image, indicating notification to the user, which the information processing system according to the second embodiment presents; and

FIG. 23 is a schematic diagram illustrating another example of the overall configuration of the information processing system according to the embodiments.

### DETAILED DESCRIPTION

The present disclosure provides an information processing method, and so forth, that can suppress deterioration in quality of cuisine, even in a case where time is limited for the user to execute food preparation processes.

In a case where the quality of the cuisine that the user has completed is low, there will be cases where that cuisine must be discarded and new cuisine completed. In this case; there is a problem that the ingredients used in the discarded cuisine, and resources such as goods, electricity, and so forth, are wasted. The present disclosure suppresses deterioration in quality of cuisine, even in a case where time is limited for the user to execute food preparation processes, so the above problem of wasted resources can be solved at the same time.

An information processing method according to an aspect of the present disclosure includes using a processor to: acquire cuisine data for a cuisine that is prepared over a plurality of food preparation processes, the cuisine data including necessary time that is required for each of the plurality of food preparation processes; accept request information for sectioning the plurality of food preparation processes into a pre-preparation process and a finishing process, the request information indicating a request for at least one of an amount of time that a user will take on the pre-preparation process and an amount of time that the user will take on the finishing process; decide a sectioning position to section the plurality of food preparation processes into the pre-preparation process and the finishing process satisfying the request information, based on the necessary time included in the cuisine data; and output the decided sectioning position to an output device.

According to this aspect, a user's time-related request regarding food preparation processes (i.e., pre-preparation process and finishing process) is accepted, and sectioning positions are decided to satisfy the accepted request. According to the information processing method according to the aspect of the present disclosure, deterioration in quality of cuisine can be suppressed, even in a case where time is limited for the user to execute food preparation processes. At the same time, the problem of wasted resources which can occur in a case where the quality of the completed cuisine is not good can be solved.

For example, the request information may indicate at least one of a first upper limit time indicating an upper limit time that the user will take for the pre-preparation process, and a second upper limit time indicating an upper limit time that the user will take for the finishing process. Deciding of the sectioning position may include deciding the sectioning position where the time required for the pre-preparation process does not exceed the first upper limit time in a case where the request information indicates the first upper limit time, and deciding the sectioning position where the time required for the finishing process does not exceed the second upper limit time in a case where the request information indicates the second upper limit time.

According to this configuration, the upper limit time for the pre-preparation process or finishing process is specifically accepted as the user's time-related request regarding food preparation processes. The sectioning position is decided so as to not exceed the accepted upper limit time. Thus, deterioration in the quality of the cuisine can be suppressed.

For example, the acquiring of the cuisine data may include acquiring the cuisine data for each of a plurality of cuisines. Accepting the request information may include the accepting of the request information indicating at least one of the first upper limit time indicating the upper limit time that the user will take for performing the pre-preparation process for all of the plurality of cuisines together, and a second upper limit time indicating an upper limit time that the user will take for individually performing the finishing process for each of the plurality of cuisines. Deciding the sectioning position may include deciding the sectioning positions for each of the plurality of cuisines.

According to this configuration, the sectioning positions are decided by classifying food preparation process for multiple cuisines so as to perform the pre-preparation processes for multiple cuisines together while performing the finishing process for each cuisine separately. Accordingly, a schedule can be compiled where pre-preparation is performed together on an off day, and the finishing processes are individually performed on weekdays.

For example, the information processing method may further include adding a restoration process to the plurality of food preparation processes to restore an intermediate ingredient created in the food preparation process from a preserved state, in a case where the sectioning position has been decided. The outputting of information indicating the sectioning position may include further outputting information indicating the added restoration process.

According to this configuration, information indicating restoration processes is also output along with the information indicating sectioning positions. Thus, the user can intuitively comprehend that a process to restore the intermediate ingredient from the preserved state is necessary, by viewing the information indicating the restoration process.

For example, the deciding of the sectioning position may include, in a case where no sectioning position that satisfies the request information exists, generating information indicating that the sectioning position does not exist. In the information processing method, information to the effect that the sectioning position does not exist may be output.

According to this configuration, the user can be made to recognize that the user's request cannot be met. This makes it easier for the user to take the next step, such as changing the request, changing conditions regarding the cuisine, and so forth.

The deciding of the sectioning position may include, in a case where no sectioning position that satisfies the request information exists, generating excess request information that exceeds the request information by a predetermined amount of time. A new sectioning position for sectioning the plurality of food preparation processes into the pre-preparation process and the finishing process that satisfies the excess request information may be decided based on the predetermined amount of time indicated in the cuisine data. The outputting of information indicating the sectioning position may further include outputting the new sectioning position that has been decided.

According to this configuration, even in a case where the user's request cannot be satisfied, in a case where the user's request can be satisfied by adding a relatively short predetermined time, the sectioning position is decided so as to satisfy the requested time to which this predetermined time has been added. Accordingly, deciding the sectioning position by handling the user's request flexibly enables deterioration of the quality of the cuisine to be suppressed.

For example, the outputting of information indicating the new sectioning position that has been decide may further include outputting the predetermined amount of time.

According to the above configuration, in a case where the sectioning position has been decided by adding the predetermined time, since the user's request could not be satisfied, the user can be notified of the added predetermined time. Accordingly, the user can recognize how much of a difference there is from his/her request.

For example, the deciding of the sectioning position may include accepting information from the user indicating whether or not to decide the new sectioning position satisfying the excess request information, and generating the excess request information and deciding the new sectioning position only in a case where information has been accepted to decide the new sectioning position. The outputting of information indicating the sectioning position may include outputting information indicating the new sectioning position that has been decided.

According to the above configuration, in a case where the sectioning position has been decided by adding the predetermined time since the users request could not be satisfied, an instruction is accepted from the user beforehand, regarding whether or not to make such a decision. Accordingly, this sectioning position can be presented to the user only in a case where the user desires for the sectioning position to be decided by adding the predetermined time.

The information processing method may further include acquiring a preservation request period calculated based on a user request. The cuisine data may further include preservation periods of intermediate ingredients created in each of the plurality of food preparation processes. The deciding of the sectioning position may include deciding the sectioning position where the preservation request period does not exceed the preservation period.

According to the above configuration, sectioning positions are decided so that periods over which intermediate ingredients are requested to be preserved (preservation request period) do not exceed preservation periods. The types of intermediate ingredients and preservation periods may change depending on where in the multiple food preparation processes the sectioning positions are set. Accordingly, when setting sectioning positions, setting the sectioning positions so that the preservation request periods do not exceed the preservation periods enables the intermediate ingredients to be preserved more appropriately, and the quality of the cuisine can be suppressed from deteriorating.

For example, the preservation period may include periods over which the intermediate ingredient can be preserved by each of a plurality of preservation methods.

According to this configuration, sectioning positions can be set so that the preservation request periods of intermediate ingredients do not exceed the preservation periods, including selecting appropriate preservation methods taking into consideration the preservation periods in cases of preserving by multiple preservation methods.

For example, the acquiring of the preservation request period may include acquiring a first point in time indicating a point in time for performing pre-preparation processes for the plurality of cuisines together, and a second point in time regarding each of the multiple cuisines, where the user individually performs finishing processes for each of the multiple cuisines, and acquiring a period having a time length from the first point in time to the second point in time for each of the multiple cuisines, as the preservation request period for each of the plurality of cuisines. Deciding of the sectioning position may include switching the second points in time of the plurality of cuisines, where the preservation request period does not exceed the preservation period.

According to this configuration, sectioning positions can be decided so as to satisfy request information of the user, by switching cuisines among days that the user has specified as days to perform finishing process. Accordingly, in a case where the user's request information cannot be satisfied unless cuisines are switched, deterioration in the quality of the cuisine can be suppressed by switching the cuisines.

The information processing method may further include generating information indicating that the second points in time regarding the plurality or cuisines have been switched with each other. The information indicating that the second points in time have been switched with each other may be output to the output device:

According to this configuration, the user can also be made to recognize that the cuisines have been switched.

An information processing system according to an aspect of the present disclosure includes: an acquisition unit that acquires cuisine data for a cuisine that is prepared over a plurality of food preparation processes using a processor, the cuisine data including necessary time that is required for each of the plurality of food preparation processes; an accepting unit that accepts request information for sectioning the plurality of food preparation processes into a pre-preparation process and a finishing process, the request information indicating a request for at least one of an amount of time that a user will take on the pre-preparation process and an amount of time that the user will take on the finishing process; a deciding unit that decides a sectioning position to section the plurality of food preparation processes into the pre-preparation process and the finishing process satisfying the request information, based on the necessary time included in the cuisine data; and an output unit that outputs information indicating the decided sectioning position on an output device.

According to this aspect, the same advantages as those of the above-described information processing method can be obtained.

It should be noted that these general or specific embodiments may be implemented as a system, a method, an integrated circuit, a computer program, or a storage medium such as a computer-readable CD-ROM or the like, or any selective combination of a system, method, integrated circuit, computer program, and storage medium.

The following is a detailed description of an embodiment with reference to the drawings. Note that the embodiments described below are all general or specific examples. Accordingly, values, shapes, materials, components, layout and connection state of components, steps, the order of steps, and so forth illustrated in the following embodiments, are only exemplary, and do not restrict the present disclosure. Components in the following embodiments which are not included in an independent Claim indicating a highest order concept are described as optional components.

### First Embodiment

Description will be made in the present embodiment regarding an information processing method, information processing system, and so forth, that can suppress deterioration in quality of cuisine, even in a case where time is limited for the user to execute food preparation processes. Note that the expression that the quality of the cuisine is “high” is a concept that includes concepts such as the flavor being absorbed well, good texture, sanitation of the cuisine, and so forth. Note that the term “cuisine” is not restricted to any particular type of food or cooking, but rather broadly covers any type of dish or cooking that is obtained by food preparation.

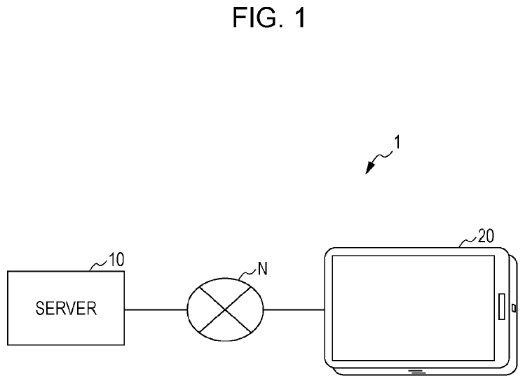

FIG. 1 is a block diagram illustrating an example of the overall configuration of an information processing system 1 according to a first embodiment. The information processing system 1 includes a server 10 and a terminal 20, as illustrated in FIG. 1. The server 10 and the terminal 20 are communicably connected by a network N.

The server 10 is a server device that acquires input of a request regarding cuisine from a user through the terminal 20, and generates and outputs information regarding food preparation processes of the cuisine based on the request regarding cuisine that has been acquired. The server 10 may physically be situated anywhere, as long as it is communicably connected to the network N. The server 10 may be realized as a server that can be used via a network, for example, a so-called cloud server.

The terminal 20 is a terminal device that accepts input regarding food preparation processes of the cuisine from the user and transmits to the server 10, and also presents information to the user based on the processing results by the server 10. The terminal 20 may be realized as a personal computer, or a mobile terminal such as a tablet terminal or smartphone or the like, for example. Although only one terminal 20 is illustrated, multiple terminals 20 may be present. In this case, users are assumed to use one terminal 20 each, but this is not restrictive.

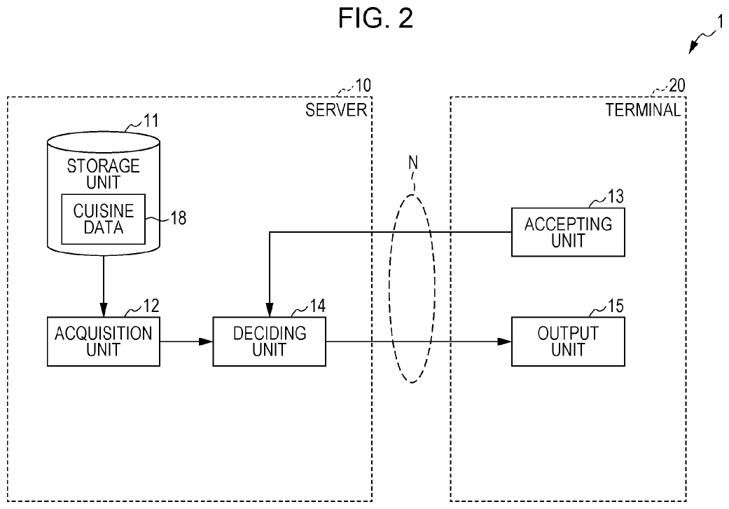

Next, the functional configuration of the information processing system 1 will be described. FIG. 2 is a block diagram illustrating the functional configuration of the information processing system 1 according to the present embodiment. The information processing system 1 includes a storage unit 11, an acquisition unit 12, an accepting unit 13, a deciding unit 14, and an output unit 15.

The storage unit 11 is a storage device that stores cuisine data 18 regarding each of one or more cuisines. The cuisine data 18 stored in the storage unit 11 is read by the acquisition unit 12. The cuisine data 18 is data regarding each of multiple food preparation processes for a cuisine that is prepared through multiple food preparation processes. More specifically, the cuisine data 18 is data indicating necessary time required for each of the multiple food preparation processes, and preservation periods of intermediate ingredients generated by the food preparation processes. The acquisition unit 12 is a processing unit that acquires cuisine data 18, regarding the cuisine that the user is going to prepare, from the storage unit 11.

The accepting unit 13 is a processing unit that accepts request information relating to food preparation processes for cuisine from the user. The accepting unit 13 specifically is request information to section the multiple food preparation processes into the pre-preparation process and finishing process. Request information indicating a request regarding at least one of the amount of time that the user will take on the pre-preparation process and the amount of time that the user will take on the finishing process is accepted. The request information that the accepting unit 13 accepts is information such as “upper limit time for pre-preparation process=30 minutes” or “upper limit time for finishing process=10 minutes”, for example. The accepting unit 13 also accepts information relating to cuisine searches and so forth from the user, in addition to the above request information.

The deciding unit 14 is a processing unit that decides sectioning positions where multiple food preparation processes of cuisines are sectioned into a pre-preparation process and a finishing process. The deciding unit 14 specifically decides sectioning positions of multiple food preparation processes for sectioning into a pre-preparation process and a finishing process so as to satisfy the above-described request information, based on the necessary time indicated in the cuisine data 18. The deciding unit 14 performs processing such as searching for cuisine and so forth, based on information relating to searching for cuisine that has been accepted from the accepting unit 13.

The request information indicates at least one of upper limit time indicating the upper limit of time that the user will take on the pre-preparation process (also referred to as “upper limit time for pre-preparation process” or “first upper limit time”), and the upper limit of time that the user will take on the finishing process (also referred to as “upper limit time for finishing process” or “second upper limit time”). In a case where the request information indicates the upper limit time for the pre-preparation process at the time of the deciding unit 14 deciding the sectioning position, the deciding unit 14 decides the sectioning position so that the time required for the pre-preparation process does not exceed the upper limit time for pre-preparation process. In a case where the request information indicates the upper limit time for the finishing process, the deciding unit 14 decides the sectioning position so that the time required for the finishing process does not exceed the upper limit time for the finishing process.

Note that the upper limit time for pre-preparation process is the upper limit of time that the user will collectively use for all pre-preparation processes of multiple cuisines. Also, the upper limit time for finishing process is the upper limit of time that the user will individually use for all pre-preparation processes of multiple cuisines.

The output unit 15 is a processing unit that outputs information indicating the sectioning position that the deciding unit 14 has decided, and notifications to the user and so forth. Information indicating the sectioning position is a recipe in which the multiple food preparation processes are sectioned into the pre-preparation process and finishing process, for example. The output unit 15 may be a display device displaying images, a speaker outputting sound, or a communication interface that transmits the images and the sound to another device. An example where the output unit 15 is a display device that displays images will be described here.

An example will be described here where the server 10 has the storage unit 11, acquisition unit 12, and deciding unit 14, and the terminal 20 has the accepting unit 13 and output unit 15, as described in FIG. 2. In this case, exchange of information between the accepting unit 13 and output unit 15, and the deciding unit 14, is performed via communication over the network N. However, relegating of functions to the server 10 and terminal 20 is not restricted to the above-described arrangement.

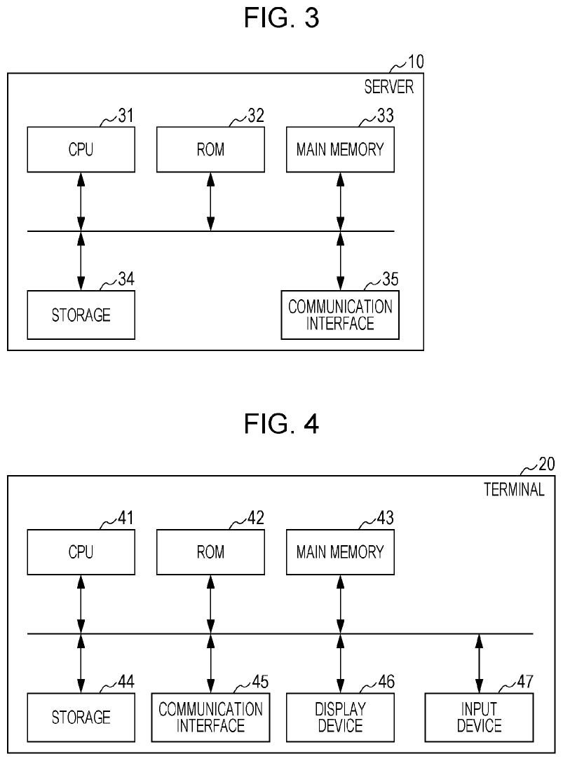

Next, an example of the hardware configurations of the server 10 and terminal 20 will be described. FIG. 3 is a block diagram illustrating an example of the hardware configuration of the server 10 according to the present embodiment.

The server 10 includes a central processing unit (CPU) 31, read-only memory (ROM) 32, main memory 33, storage 34, and a communication interface 35, as illustrated in FIG. 3. The CPU 31 is a processor that executes control programs stored in the ROM 32 or storage 34 or the like. The ROM 32 is a read-only storage region that stores control programs and the like. The main memory 33 is a volatile storage region used as a work area when the CPU 31 executes control programs. The storage 34 is a non-volatile storage region that stores control programs, contents, and so forth.

The communication interface 35 is a communication interface that transmits and receives communication data. The communication interface 35 is a wired communication interface that conforms to the IEEE 802.3 standard or the like, or a wireless communication interface that conforms to IEEE 802.11a, b, g, or n standards or the like. The communication interface 35 has a communication signals generating circuit, and an antenna or connector, or the like. The communication interface 35 may also perform communication via cellular communication conforming to the Long-Term Evolution (LTE) standard or the like.

The storage unit 11 in FIG. 2 can be realized by the storage 34, for example. The acquisition unit 12, deciding unit 14, and output unit 15 can be realized by the CPU 31 executing programs using the main memory 33 and so forth. The output unit 15 can be realized using the communication interface 35.

FIG. 4 is a block diagram illustrating an example of the hardware configuration of the terminal 20 according to the present embodiment. The terminal 20 includes a CPU 41, ROM 42, main memory 43, storage 44, a communication interface 45, a display device 46, and an input device 47, as illustrated in FIG. 4. The CPU 41, ROM 42, main memory 43, storage 44, and communication interface 45, are the same as the components of the same names in the server 10.

The display device 46 is a display device that displays information as images. The display device 46 is, for example, a liquid crystal display, an organic electroluminescence (EL) display, or the like. The input device 47 is an input device that accepts input operations by the user, examples of which include a touchscreen, keyboard, mouse, or the like. Note that the display device 46 and input device 47 can be realized as a touchscreen display.

For example, the accepting unit 13 and output unit 15 in FIG. 2 can be realized by the CPU 41 executing programs using the main memory 43 and communication interface 45 and so forth. The input device 47 may further be used in realizing of the accepting unit 13, and the display device 46 in realizing of the output unit 15. Note that the hardware configurations of the server 10 and terminal 20 are not restricted to the above-described examples, and that part or all of the above-described configurations may be configured by dedicated hardware.

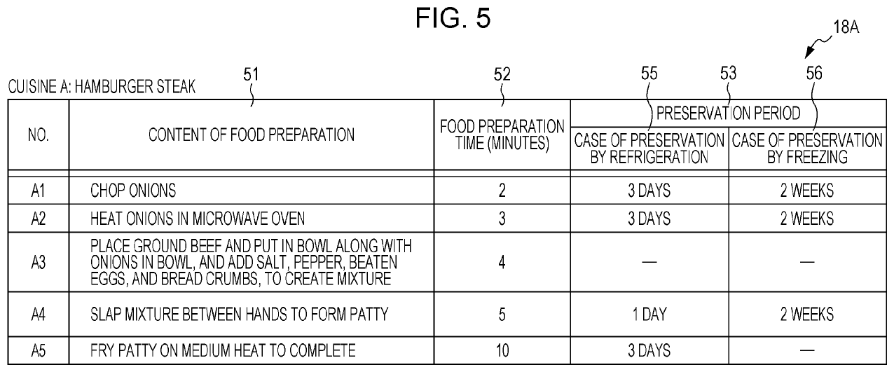

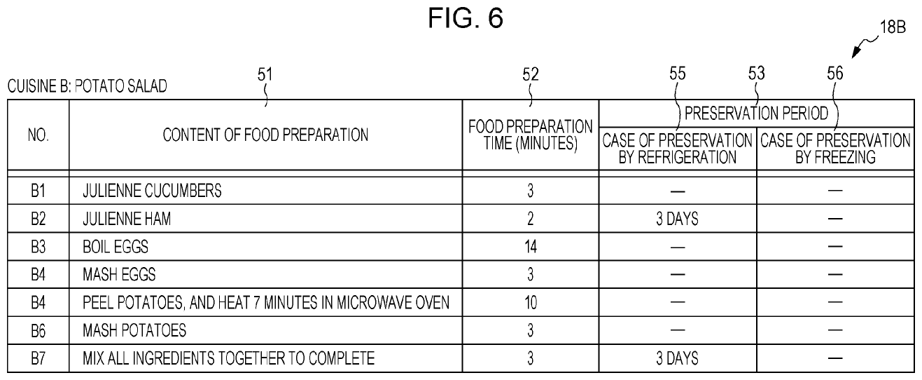

Next, the cuisine data 18 will be described in detail. FIGS. 5 and 6 are diagrams describing first and second examples of the cuisine data 18 (cuisine data 18A and 18B) according to the present embodiment. The cuisine data 18A illustrated in FIG. 5 is cuisine data relating to cuisine A “hamburger steak”, and the cuisine data 18B illustrated in FIG. 6 is cuisine data relating to cuisine B “potato salad”, These may be simply referred to as “cuisine A” and “cuisine B” hereinafter. The cuisine data 18A and 18B include each information of food preparation content 51, food preparation time 52, and preservation period 53.

The food preparation content 51 is information indicating a food preparation method in that food preparation process. For example, the food preparation content of a food preparation process A1 for cuisine A is “chop onions”. The food preparation content of a food preparation process B3 for cuisine B is “boil eggs”.

The food preparation time 52 is information regarding necessary time required for that food preparation process. For example, the food preparation time for food preparation process A1 for cuisine A is two minutes, and the food preparation time for food preparation process B3 for cuisine B is 14 minutes.

The preservation period 53 is information regarding the period, i.e., the amount of time, over which the intermediate ingredient generated in this food preparation process can be preserved. For example, the preservation period of the intermediate ingredient generated in the food preparation process A1 for cuisine A is three days in the case of preservation by refrigeration, and two weeks in the case of preservation by freezing. On the other hand, the intermediate ingredient generated by the food preparation process B3 for cuisine B cannot be preserved. Note that in FIGS. 5 and 6, a hyphen “-” means that the intermediate ingredient cannot be preserved, or that preservation is not recommended.

Note that the preservation period 53 may include a system of multiple preservation periods by preservation method. Examples of preservation methods include in addition to the above described refrigeration (around 5° C.) and freezing (around −18° C.), partially frozen (a half-frozen or slightly frozen state around −3° C.), a chilled state (immediately above freezing, around 0° C.), and so forth. Any number of these one or more preservation methods may be employed. FIGS. 5 and 6 illustrate preservation periods 55 and 56 in a case where there are refrigeration and freezing as preservation methods, as an example.

In FIGS. 5 and 6, food preparation process where a period is listed in the column preservation period 53 is a food preparation process where the intermediate ingredient generated in this food preparation process can be preserved, and is a food preparation process that can serve as a sectioning position for sectioning into the pre-preparation process and finishing process, in other words a candidate for a sectioning position. On the other hand, a food preparation process where no period is listed in the column preservation period 53 is a food preparation process regarding which the intermediate ingredient cannot be preserved, or that preservation is not recommended.

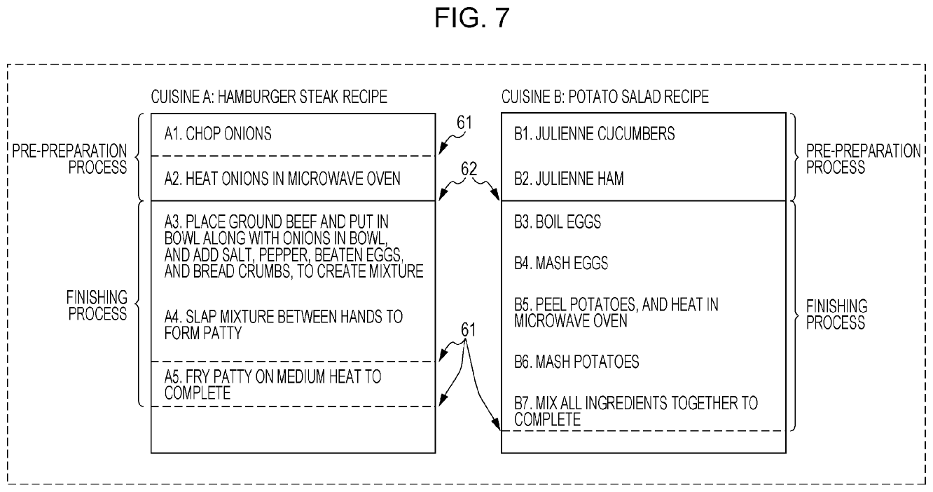

Next, the sectioning position for sectioning into the pre-preparation process and finishing process will be described. FIG. 7 is an explanatory diagram of sectioning positions according to the present embodiment. FIG. 7 shows the recipes for cuisines A and B section into the pre-preparation process and finishing process. Candidates for sectioning positions are indicated by doted lines 61 in FIG. 7, and sectioning positions decided by the deciding unit 14 are indicated by solid lines 62. In each of the cuisines A and B, the food preparation process A1 and A2, and B1 and B2, listed above the sectioning position, are pre-preparation processes, and the food preparation processes A3 through A5 and B3 through B7, listed below the sectioning position, are finishing processes.

The user references the recipe sectioned into the pre-preparation process and the finishing process, and completes the cuisine. Specifically, the user performs the pre-preparation process, and then preserves the intermediate ingredient generated in the pre-preparation process by refrigeration or the like. Several days later, the user performs the finishing process on the preserved intermediate ingredient and competes the cuisine. At this time, the user can intuitively comprehend each of the pre-preparation process and the finishing process by viewing the recipes for cuisines A and B illustrated like those in FIG. 7.

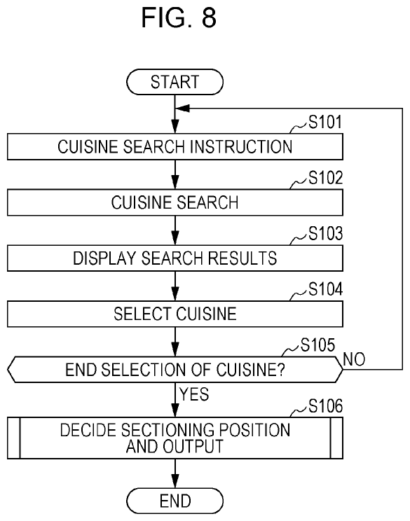

Next, the operations of the information processing system 1 configured as described above will be described. FIG. 8 is a flowchart of the information processing method according to the present embodiment. The operations of the information processing system 1 will be described regarding a case where the finishing process is performed on each weekday of the week for multiple cuisines that the user has specified, and the pre-preparation process for one week worth is performed on Sunday, immediately prior to the weekdays.

In step S101, the accepting unit 13 accepts a search instruction for a cuisine. The accepting unit 13 accepts a text string indicating the name of the cuisine (e.g., hamburger steak, potato salad, etc.), genre of cuisine (e.g., meat, fish, Japanese, Western, Chinese, etc.), ingredient used in the cuisine (beef, sardine, etc.), method of food preparation (e.g., grilling, frying, boiling, stewing, etc.), via the input device 47.

In step S102, the deciding unit 14 performs a search for cuisine based on the text string that the accepting unit 13 has accepted. Specifically, the deciding unit 14 accesses the cuisine data 18 via the acquisition unit 12, and acquires cuisines matching the text string accepted by the accepting unit 13. More specifically, the deciding unit 14 searches for a cuisine that includes the name of cuisines or the like accepted by the accepting unit 13 in part or all of name of cuisine, genre of cuisine, ingredient used in cuisine, food preparation method, or the like.

In step S103, the output unit 15 displays the results of the search by the deciding unit 14. One or more cuisine is included in the search results.

In step S104, the accepting unit 13 accepts a section by the user regarding the search results displayed on the output unit 15. The user selects the cuisine to prepare from the one or more cuisines displayed on the output unit 15.

In step S105, the accepting unit 13 accepts a user selection regarding whether to end selection of cuisine. For example, the accepting unit 13 displays a question on the output unit 15 such as, “End selection of cuisine?”, and accepts a positive reply (Yes) or a negative reply (No) as a reply to the question, thereby accepting this selection. In a case where a reply to end selection of cuisine is received in step S105, the flow advances to step S106, In a case of obtaining a reply to not end selection, step S101 is executed again. The processing of steps S101 through S105 is repeated until selection of one week worth of multiple types of cuisines has been selected. Note that determination may be made in step S105 that selection of cuisine has ended, in a case where a predetermined number of cuisines has been selected for each of the weekdays of the week.

In step S106, the information processing system 1 performs processing for deciding and outputting sectioning positions. This processing will be described later in detail.

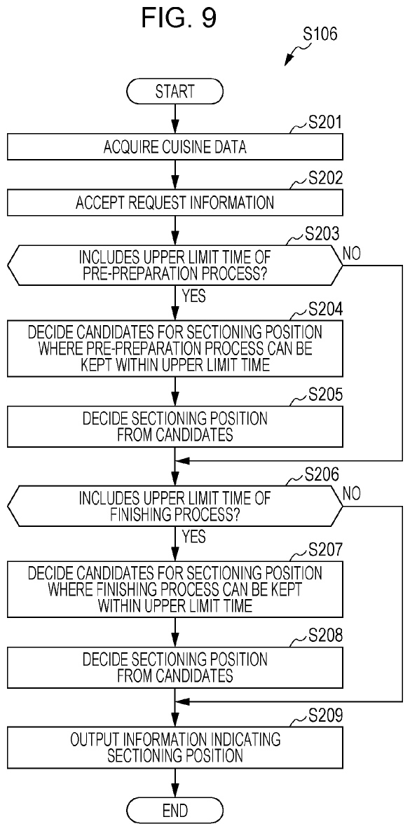

FIG. 9 is a flowchart illustrating processing for deciding and outputting sectioning positions by the information processing system 1 according to the present embodiment. FIG. 9 is a flowchart illustrating detailed processing of step S106 in FIG. 8.

In step S201, the acquisition unit 12 acquires the cuisine data 18 relating to the cuisine that the user is going to prepare. More specifically, the acquisition unit 12 acquires the cuisine data 18 relating to the one or more cuisines that the user has selected in step S104.

In step S202; the accepting unit 13 accepts request information relating to the food preparation process from the user. Specifically, the accepting unit 13 accepts request information for sectioning the multiple food preparation processes into the pre-preparation process and finishing process, indicating at least one of the amount of time that the user will take on the pre-preparation process and the amount of time that the user will take on the finishing process.

In step S203, the deciding unit 14 determines whether or not the request information accepted from the user in step S202 includes upper limit time for the pre-preparation process. In a case where the deciding unit 14 determines that the request information includes upper limit time of the pre-preparation process (Yes in step S203), the flow advances to step S204; otherwise (No in step S203), the flow advances to step S206.

In step S204, the deciding unit 14 decides candidates for the sectioning position that will enable the pre-preparation process to be kept within the upper limit time included in the request information acquired in step S202. The deciding unit 14 here decides those, where the time required to perform all pre-preparation processes of each of the cuisine data 18 acquired in step S202 is within the upper limit time for the pre-preparation process included in the request information, as candidates.

Note that in a case where no candidates are obtained in step S204, the deciding unit 14 may add a relatively short predetermined time to the upper limit time included in the request information, to decide a candidate. It is sufficient for the predetermined time to be added to be a relatively short time in comparison with the upper limit time included in the request information, and may be a fixed amount of time (e.g., three minutes or five minutes) or may be an amount of time set based on the upper limit time included in the request information (e.g., 10% to 20% of the upper limit time). Note that the predetermined time is equivalent to predetermined time indicated by excess request information. Alternatively, information may be generated indicating that there are no candidates, and the flow proceed to the next process.

In step S205, the deciding unit 14 decides a sectioning position from the sectioning position candidates decided in step S204. Any method may be used to decide the sectioning position. For example, a sectioning position candidate that has the longest time required for the pre-preparation process may be selected. In a case where the intermediate ingredient generated by the same food preparation process can be preserved by multiple methods, the deciding unit 14 may select the preservation method by which the quality of the ultimately completed cuisine is the better. For example, in a case where preservation by both refrigeration and freezing is possible, refrigeration is generally considered to result in better quality cuisine, so preservation by refrigeration may be selected. In a case of a particular intermediate ingredient where the quality of the cuisine will be better if preserved by freezing, preservation by freezing may be selected. In a case of having generated information that there are no candidates in step S204, the deciding unit 14 does not decide sectioning positions.

In step S206, the deciding unit 14 determines whether or not the request information accepted from the user in step S202 includes upper limit time for the finishing process. In a case where the deciding unit 14 determines that the request information includes upper limit time for the finishing process (Yes in step S206), the flow advances to step S207; otherwise (No in step S206) the flow advances to step 3209.

In step S207, the deciding unit 14 decides candidates for the sectioning position that will enable the finishing process to be kept within the upper limit time included in the request information acquired in step S202. The deciding unit 14 here decides those, where the time required to perform all finishing process of each of the cuisine data 18 acquired in step S202 is within the upper limit time for the finishing process included in the request information, as candidates. The deciding unit may also group each of the cuisine data 18 acquired in step S202 by the day on which the finishing process is to be performed, and take as candidates those where the time necessary to perform all of the finishing processes of each of the cuisines included in each group is within the upper limit time of the finishing process included in the request information, Note that in a case where no candidates are obtained in step 3207, the deciding unit 14 may add a relatively short predetermined time to the upper limit time included in the request information, to decide a candidate, or may generate indicating that there are no candidates, and proceed to the next process, the same as in step S204.

In step S208, the deciding unit 14 decides a sectioning position from the sectioning position candidates decided in step S207. Any method may be used to decide the sectioning position. For example, the deciding unit 14 may select a sectioning position candidate that has the longest time required for the finishing process. In a case of having generated information that there are no candidates n step S207, the deciding unit 14 does not decide sectioning positions.

In step S209, the output unit 15 outputs information indicating the sectioning position that the deciding unit 14 has decided in step S205 or S208.

There are cases where the request information that the accepting unit 13 acquires in step S202 includes request information indicating a request for both time required for the pre-preparation process and time required for the finishing process. In this case, both the sectioning position decided based on the upper limit time for the pre-preparation process in step S205 and the sectioning position decided based on the upper limit time for the finishing process in step S208 exist. In such a case, either one (e.g., a predetermined one) of the two sectioning positions may be employed.

According to the above series of processing, the information processing system 1 can suppress deterioration in quality of cuisine, even in a case where time is limited for the user to execute food preparation processes.

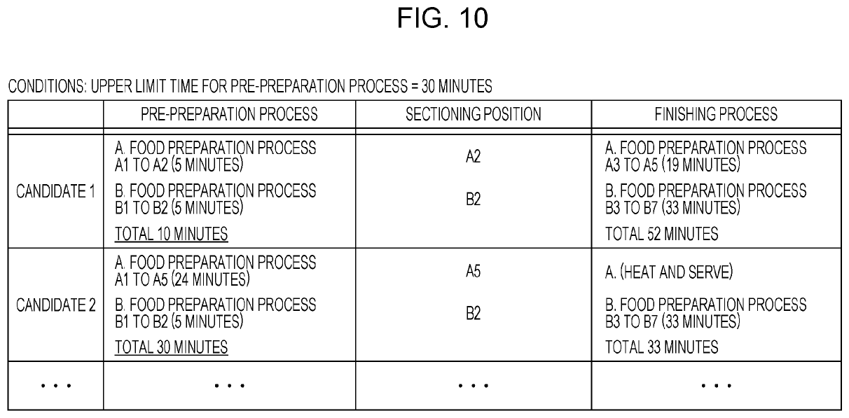

Two examples will be described below, using specific numerical values in the processing by the information processing system 1. FIG. 10 is an explanatory diagram illustrating a first example of sectioning position deciding processing according to the present embodiment. FIG. 10 illustrates a candidate 1 and a candidate 2, which are part of sectioning position candidates decided in step S204 by the deciding unit 14, in a case of having received a condition of “upper limit time for pre-preparation process=30 minutes” as request information.

For example, candidate 1 includes food preparation processes A1 and A2 for cuisine A and food preparation processes B1 and B2 for cuisine B as the pre-preparation process, the total necessary time of these being 10 minutes. Candidate 1 also includes food preparation processes A3 through A5 for cuisine A and food preparation processes B3 through B7 for cuisine B as the finishing process, the total necessary time of these being 52 minutes. The sectioning position in this case is food preparation process A2 for cuisine A, and food preparation process B2 for cuisine B.

Also, candidate 2 includes food preparation processes A1 through A5 for cuisine A and food preparation processes B1 and B2 for cuisine B as the pre-preparation process, the total necessary time of these being 30 minutes. Candidate 2 also includes heating and serving for cuisine A and food preparation processes B3 through B7 for cuisine B as the finishing process, the total necessary time of these being 33 minutes. The sectioning position in this case is food preparation process A5 for cuisine A, and food preparation process B2 for cuisine B.

In this case, the deciding unit 14 decides one of the sectioning position candidates decided in step S204, i.e., candidate 1 or candidate 2 as the sectioning position (step S205). In a case of deciding the candidate that has the longest time required for the pre-preparation process as the sectioning position, the deciding unit 14 will decide the candidate 2 that requires 30 minutes for the pre-preparation process as the sectioning position.

Now, the necessary time of multiple food preparation processes is calculated simply by adding the necessary time for each of the multiple food preparation processes. Note however, that the method of calculating the necessary time for multiple food preparation processes is not restricted to this. For example, the necessary time for food preparation processes that can be performed concurrently will be shorter than the time calculated by simple addition.

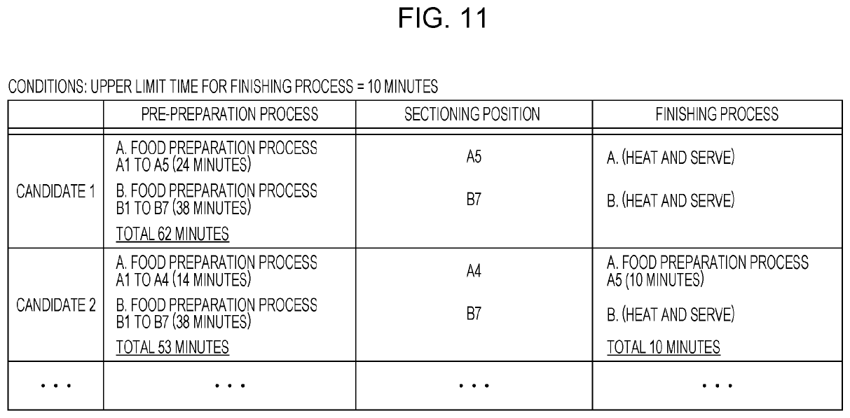

FIG. 11 is an explanatory diagram illustrating a second example of sectioning position deciding processing according to the present embodiment. FIG. 11 illustrates a candidate 1 and a candidate 2, which are part of sectioning position candidates decided in step S204 by the deciding unit 14, in a case of having received a condition of “upper limit time for finishing process=10 minutes” as request information conditions.

For example, candidate 1 includes food preparation processes A1 through A5 for cuisine A and food preparation processes B1 through B7 for cuisine B as the pre-preparation process, the total necessary time of these being 62 minutes. Cuisines A and B are heated and serve as the finishing process. The sectioning position in this case is food preparation process A5 for cuisine A, and food preparation process B7 for cuisine B.

Also, candidate 2 includes food preparation processes A1 through A4 for cuisine A and food preparation processes B1 through B7 for cuisine B as the pre-preparation process, the total necessary time of these being 53 minutes, Candidate 2 also includes food preparation process A5 for cuisine A as the finishing process, the total necessary time thereof being 10 minutes. The sectioning position in this case is food preparation process A4 for cuisine A, and food preparation process B7 for cuisine B.

In this case, the deciding unit 14 decides one of the sectioning position candidates decided in step S207, i.e., candidate 1 or candidate 2 as the sectioning position (step S208). In a case of deciding the candidate that has the longest time required for the pre-preparation process as the sectioning position, the deciding unit 14 will decide the candidate 1 that requires 62 minutes for the pre-preparation process as the sectioning position. Although the necessary time for finishing process has been calculated deeming the time required for heating and serving the cuisine to be zero here, the necessary time for finishing process may be calculated with a time that is not zero (e.g., around one to three minutes) for heating and serving.

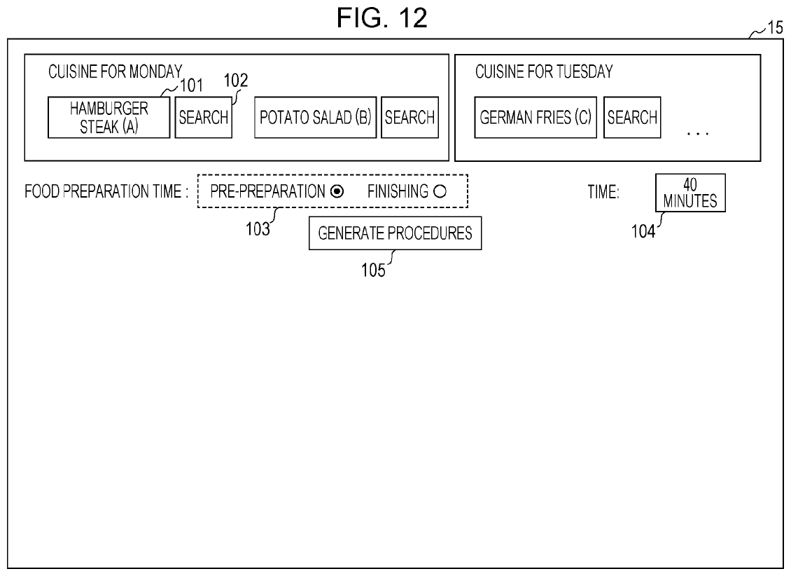

Images displayed by the information processing system 1 will be described below. FIG. 12 is an explanatory diagram illustrating a first example of an image indicating food preparation process that the information processing system 1 according to the present embodiment presents. The image illustrated in FIG. 12 is an image that the output unit 15 displays when the accepting unit 13 is to accept search instructions for cuisine, request information, and so forth, from the user.

The image displayed on the output unit 15 includes spaces 101 and 104, buttons 102 and 105, and a radio button group 103. The space 101 is an input space for inputting the name of the cuisine or the like, to accept a search instruction for a cuisine from the user, and also is a display space that displays the name of the cuisine that has been selected. The button 102 is a button for accepting a search instruction for cuisine from the user. Upon the user operating the button 102 in a state where the name of a cuisine or the like is input in the space 101, the deciding unit 14 performs a search for cuisine based on the name of the cuisine or the like input in this space 101 at the time that the button 102 is operated (step S102).

The radio button group 103 includes buttons for the user to select which of the pre-preparation process and finishing process to use for setting the food preparation time. The space 104 is an input space for the user to input a desired food preparation time. The button 105 is a button for accepting an instruction to create food preparation procedures that satisfy the request for food preparation time that the user desires. Upon the user operating the radio button group 103 and operating the button 105 in a state where food preparation times has been input to the space 104, the accepting unit 13 accepts that the user will spend the food preparation time input to the space 104 for the one of pre-preparation process and finishing process that has been selected by the radio button group 103 (step S202).

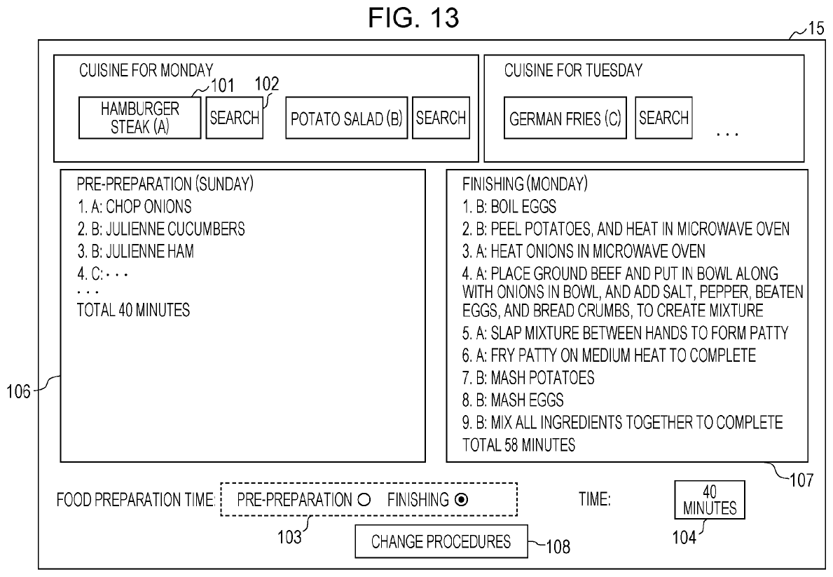

FIG. 12 illustrates a state where a user request has been input that the time taken for pre-preparation process is to be 40 minutes, with hamburger steak and potato salad selected as the cuisine for Monday, and German fries and so forth selected for Tuesday. Upon the button 105 being operated in this state, the accepting unit 13 accepts this operation, and displays the image illustrated in FIG. 13 on the output unit 15 after sectioning position decision by the deciding unit 14.

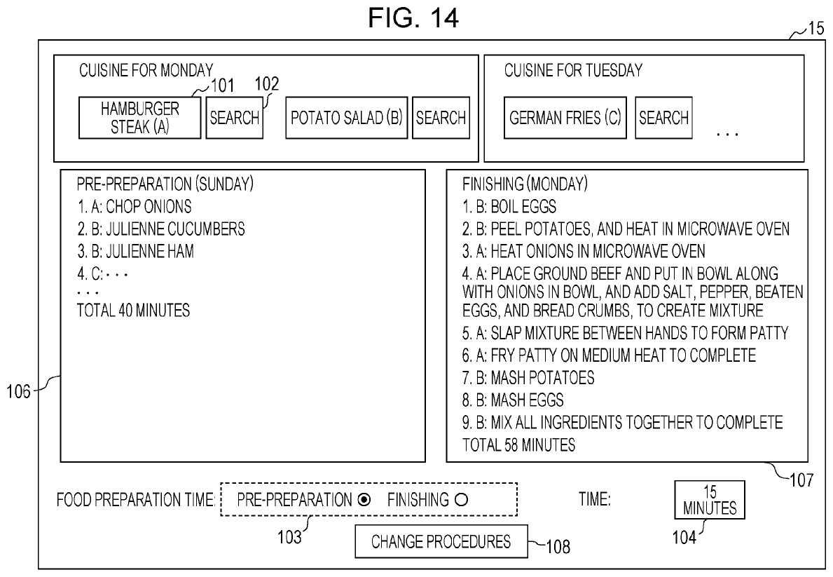

FIGS. 13 and 14 are explanatory diagrams illustrating a second example and third example of images indicating food preparation processes that the information processing system 1 according to the present embodiment presents. The image illustrated in FIG. 13 is an image where the output unit 15 is displaying sectioning positions decided by the deciding unit 14.

In the image displayed in FIG. 13, the spaces 101 and 104, the button 102, and the radio button group 103 are the same as those in the image illustrated in FIG. 12, so description will be omitted here and in subsequent description. The image illustrated in FIG. 13 further includes spaces 106 and 107, and a button 108.

Space 106 is a display space for displaying food preparation processes that have been classified as pre-preparation processes by the sectioning position decided by the deciding unit 14. The space 106 includes the food preparation process A1 for the hamburger steak and the food preparation processes B1 and B2 for the potato salad. The total of necessary time for pre-preparation process included in the space 106 is 40 minutes, satisfying the request information of “upper limit time for pre-preparation process=40 minutes” by the user.

Space 107 is a display space for displaying food preparation processes that have been classified as finishing processes by the sectioning position decided by the deciding unit 14. The space 107 includes the food preparation processes A2 through A5 for the hamburger steak and the food preparation processes B3 through B7 for the potato salad. The total of necessary time for pre-preparation process included in the space 107 is 58 minutes. The food preparation processes in each of the spaces 106 and 107, and the necessary time thereof, have been decided based on the sectioning position decided by the deciding unit 14 so as to satisfy the request information that the accepting unit 13 has accepted.

The button 108 is a button for accepting changing of the request regarding food preparation time by the user, i.e., an instruction to change the food preparation procedures. When the button 108 is operated, the accepting unit 13 accepts that the user will take the food preparation time input to the space 104 for the one of the pre-preparation process or finishing process that has been selected by the radio button group 103 (step S202), in the same way as when the button 105 (see FIG. 12) is operated.

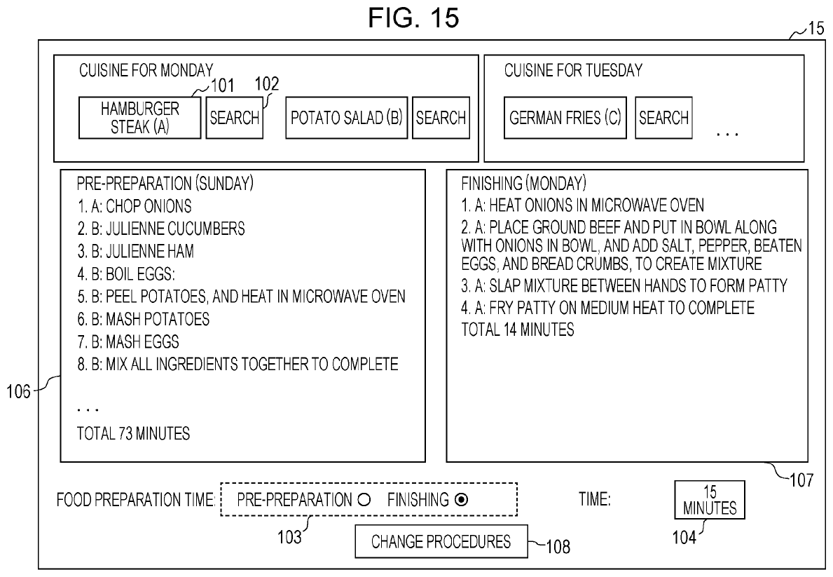

Now, a case will be assumed where the user feels that the 58 minutes of food preparation processes on Monday is too long, and desires to shorten this to 15 minutes. In this case, the user selects finishing process using the radio button group 103 and inputs “15 minutes” in the space 104 (see FIG. 14), and operates the button 108. Upon the accepting unit 13 accepting this operation, the deciding unit 14 newly decides sectioning positions based on the request information “upper limit time for finishing process=15 minutes”, and the output unit 15 displays the image illustrated in FIG. 15.

FIG. 15 is an explanatory diagram illustrating a fourth example of an image indicating food preparation processes that the information processing system 1 according to the present embodiment presents. The spaces 106 and 107 illustrated in FIG. 15 include the pre-preparation processes and finishing processes decided by the deciding unit 14 based on the new request information accepted from the user in FIG. 14.

The space 106 includes the food preparation process A1 for the hamburger steak and the food preparation processes B1 through B7 for the potato salad. The total of necessary time for pre-preparation process included in the space 106 is 73 minutes.

The space 107 includes the food preparation processes A2 through A5 for the hamburger steak. The total of necessary time for pre-preparation process included in the space 107 is 14 minutes, satisfying the new request information of “upper limit time for finishing process=15 minutes” by the user. Thus, the sectioning position for sectioning into the pre-preparation processes and finishing processes is appropriately set based on request information indicating user requests.

Note that new processes may be added to the spaces 106 and 107 displaying the food preparation processes, due to having sectioned the flow of a recipe into a pre-preparation process and a finishing process. That is to say, in a case of having decided a sectioning position, multiple processes such as a process of preserving the generated intermediate ingredient and a process of restoring the intermediate ingredient from the preserved state, may be added to the food preparation processes. In this case, the output unit 15 further outputs information indicating the added preservation process and restoration process when outputting information indicating the sectioning position.

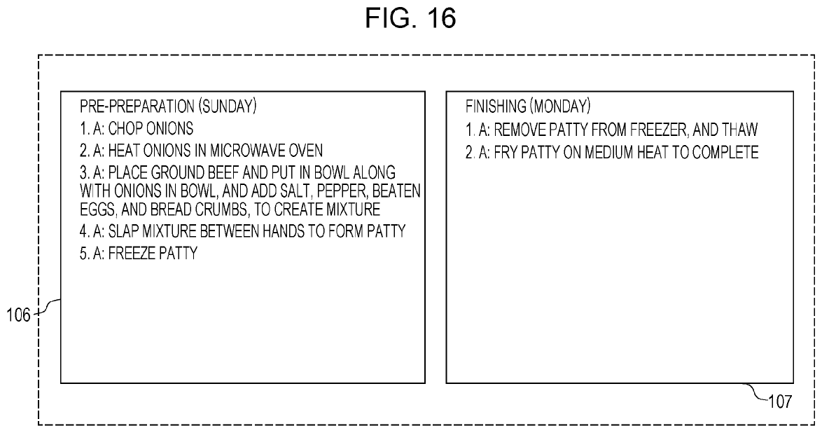

FIG. 16 is an explanatory diagram illustrating addition of processes by the information processing system 1 according to the present embodiment. FIG. 16 illustrates a case of preparing just a hamburger steak, with the food preparation processes A1 through A4 being performed as the pre-preparation process, and the food preparation process A5 being performed as the finishing process.

In this case, a process of “Freeze formed patty”, meaning that the intermediate ingredient generated in food preparation process A4 is to be preserved by freezing, is added to the space 106 after the food preparation processes A1 through A4. Also, a process of “Remove patty from freezer and thaw” meaning that the preserved intermediate ingredient is to be restored from the preservation state, is added to the space 107. This enables the user to intuitively comprehend the need to perform a process of preserving the “patty” that is the intermediate ingredient, and a process of restoring from the preserved state.

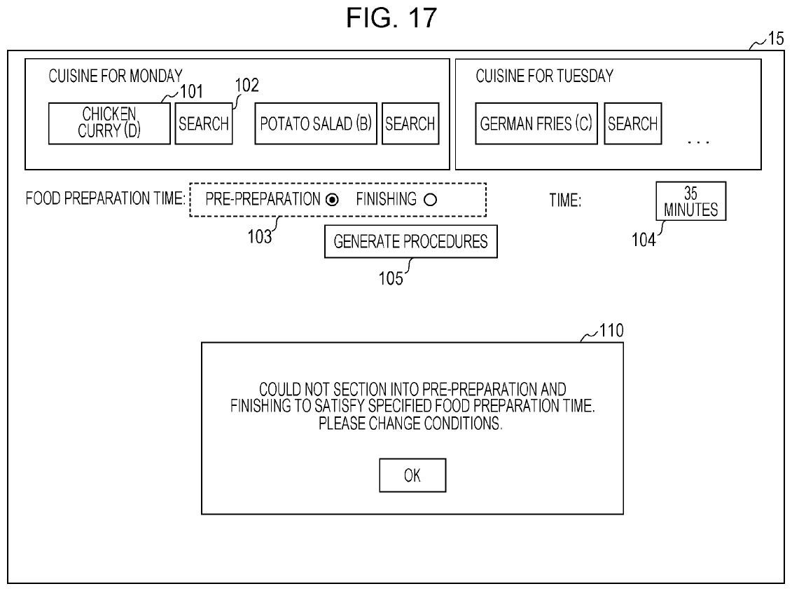

Next, an image indicating a notification that the information processing system 1 presents, made to the user, will be described. FIG. 17 is an explanatory diagram illustrating a first example of an image (image 110) showing a notification made to the user, which the information processing system 1 according to the present embodiment presents.

The image 110 is an example of an image presented when the deciding unit 14 cannot decide a sectioning position that will satisfy the requested time specified by the user, i.e., in a case when the deciding unit 14 generates information to the effect that there are not candidates (steps S204 and S207). That is to say, in a case where there is no sectioning position that satisfies the request information when the deciding unit 14 decides the sectioning position, the output unit 15 may output information indicating that there is no sectioning position.

Although FIG. 17 illustrates an example where the output unit 15 displays the image 110 superimposed on the image displayed for searching for cuisine (see FIG. 12), a display of the image 110 alone may be made. This holds true for the other drawings as well. Upon seeing the image 110, the user will know that a sectioning position satisfying the request information cannot be set, and realize that the request information needs to be changed. The user can then input new and different request information.

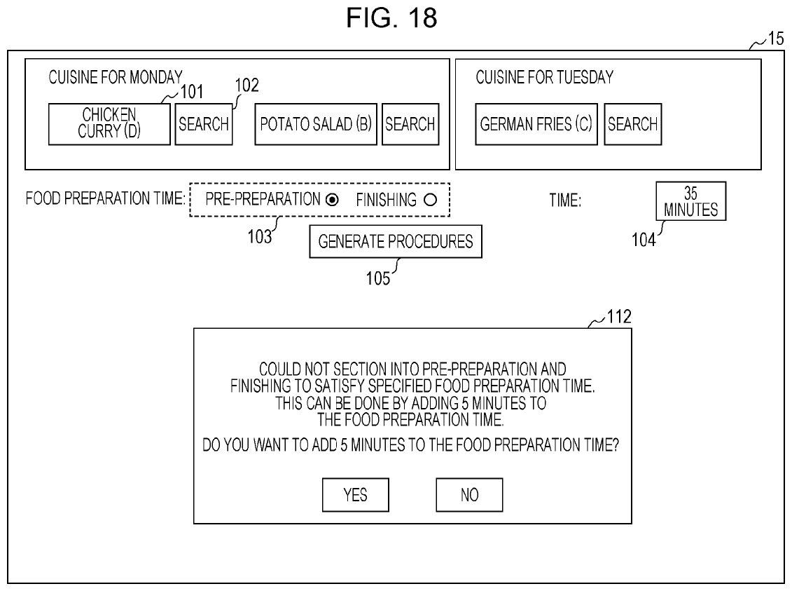

FIG. 18 is an explanatory diagram illustrating a second example of an image (image 112) showing a notification made to the user, which the information processing system 1 according to the present embodiment presents. The image 112 is an example of an image presented when the deciding unit 14 cannot decide a sectioning position that will satisfy the requested time specified by the user, but can decide a sectioning position that will satisfy the requested time if five minutes are added to the requested time that the user has specified. Note that the five minutes is equivalent to the predetermined time indicated by excess request information.

Upon viewing the image 112, the user knows that cannot sectioning position that will satisfy the requested information cannot be set, but a sectioning position that will satisfy the requested information can be decided if five minutes are added. In a case where the user desires to decide the sectioning position with new request information with five minutes added, the user operates the “Yes” button in image 112, whereby a sectioning position is decided based on the new request information. In a case where the “Yes” button is operated, sectioning position deciding processing (steps S202 through S209) is performed using time obtained by adding five minutes to the upper limit time, as the new upper limit time.

Thus, the information processing system 1 may generate excess request information, decide a new sectioning position, and output information indicating the now sectioning position that has been decided, only in a case of having accepted information from the user indicating to decide a new sectioning position that will satisfy the excess request information. In a case of not performing deciding of a sectioning position based on new request information, the user can return to the original state (e.g., FIG. 12) by operating the “No” button.

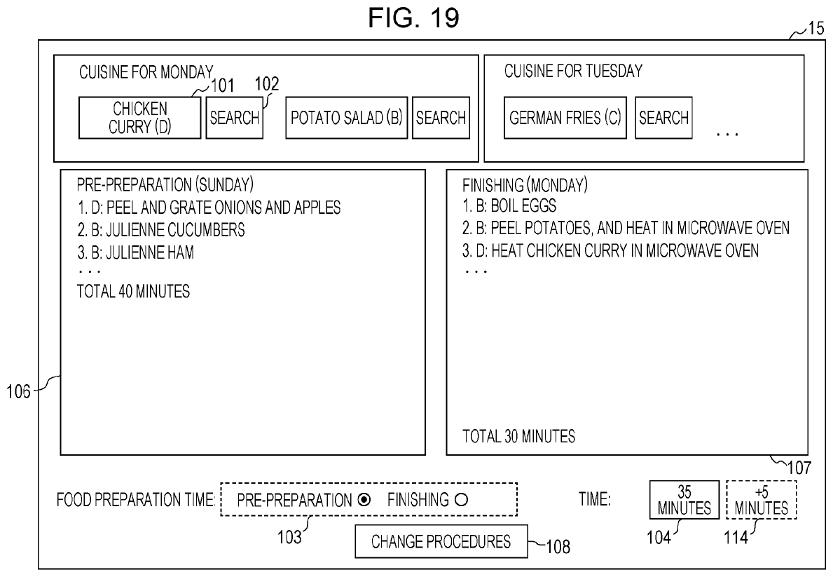

FIG. 19 is an explanatory diagram illustrating a third example of an image showing a notification made to the user, which the information processing system 1 according to the present embodiment presents. The image illustrated in FIG. 19 shows the pre-preparation processes and finishing processes based on sectioning positions decided based on new request information in a case where the user has pressed the “Yes” button in the state in FIG. 18. The image shown in FIG. 19 is similar to the image shown in FIG. 13, but an image 114 has been added to the space for food preparation time, showing the added time “5 minutes”.

That is to say, in a case where the deciding unit 14 has decided a new sectioning position to satisfy excess request information, the output unit 15 outputs information indicating the new sectioning position. The predetermined time in the excess request information may be output at this time as well. By viewing this display, the user is not presented with just the pre-preparation processes and finishing processes using request information of “upper limit time of pre-preparation process=40 minutes”, Rather, the user can more accurately recognize that a search was attempted using the request information “upper limit time of pre-preparation process=35 minutes” but the desired results were not obtainable, and the current results have been obtained by subsequently adding “5 minutes” and searching with this requested time.

According to the information processing of the present embodiment described above, a user's time-related request regarding food preparation processes (i.e., pre-preparation process and finishing process) is accepted, and sectioning positions are decided to satisfy the accepted request. According to the information processing method according to an aspect of the present disclosure, deterioration in quality of cuisine can be suppressed, even in a case where time is limited for the user to execute food preparation processes. At the same time, the problem of wasted resources which can occur in a case where the quality of the completed cuisine is not good can be solved.

Specifically, the upper limit time for the pre-preparation process or finishing process is accepted as the user's time-related request regarding food preparation processes. The sectioning position is decided so as to not exceed the accepted upper limit time. Thus, deterioration in the quality of the cuisine can be suppressed.

The sectioning positions are decided by classifying food preparation process for multiple cuisines so as to perform the pre-preparation processes for multiple cuisines together while performing the finishing process for each cuisine separately. Accordingly, a schedule can be compiled where pre-preparation is performed together on an off day, and the finishing processes are individually performed on weekdays.

Information indicating restoration processes is also output along with the information indicating sectioning positions. Thus, the user can intuitively comprehend the need for a process to restore the intermediate ingredient from the preserved state by viewing the information indicating the restoration process.

Further, the user can be made to recognize that the user's request cannot be met. This makes it easier for the user to take the next step, such as changing the request, changing conditions regarding the cuisine, and so forth.

Even in a case where the user's request cannot be satisfied, in a case where the user's request can be satisfied by adding a relatively short predetermined time, the sectioning position is decided so as to satisfy the requested time to which this predetermined time has been added. Accordingly, deciding the sectioning position by handling the user's request flexibly enables deterioration of the quality of the cuisine to be suppressed.

In a case where the sectioning position has been decided by adding the predetermined time, since the user's request could not be satisfied, the user can be notified of the added predetermined time. Accordingly, the user can recognize how much of a difference there is from his/her request.

In a case where the sectioning position has been decided by adding the predetermined time since the user's request could not be satisfied, an instruction is accepted from the user beforehand, regarding whether or not to make such a decision. Accordingly, this sectioning position can be presented to the user only in a case where the user desires for the sectioning position to be decided by adding the predetermined time.

### Second Embodiment

Description will be made in a second embodiment regarding an information processing method, information processing system, and so forth, that can suppress deterioration in quality of cuisine, even in a case where time is limited for the user to execute food preparation processes. Particularly, an information processing method and so forth will be described that suppresses deterioration in quality of cuisine within the constraint of satisfying preferences of the user regarding the day on which to perform the finishing process. The configuration of the information processing system according to the present embodiment is the same as the configuration in the first embodiment (see FIGS. 1 through 4). Hereinafter, description will be made primarily regarding points that differ from the configuration in the first embodiment.

The accepting unit 13 accepts request information relating to food preparation processes of cuisines, in the same way as the accepting unit 13 in the first embodiment. The accepting unit 13 also accepts specification of a day on which to perform the finishing process for a cuisine that the user is going to prepare. For example, the accepting unit 13 accepts an instruction regarding the cuisine “hamburger steak” that the user is going to prepare, to perform the finishing process thereof on Monday, and accepts an instruction regarding the cuisine “potato salad” that the user is going to prepare, to perform the finishing process thereof on Thursday. Note that the day on which the pre-preparation process is performed is also referred to as “first point in time”, and the day on which the finishing process is performed is also referred to as “second point in time”.

The deciding unit 14 decides sectioning positions for sectioning multiple food preparation processes of cuisines into pre-preparation process and finishing process, in the same way as the deciding unit 14 in the first embodiment. At this time, the deciding unit 14 decides the sectioning positions taking into consideration the day on which the finishing process if the cuisine is to be performed, which has been received from the accepting unit 13. At this time, the intermediate ingredient needs to be preserved from the day on which the pre-preparation process is performed until the day on which the finishing process is performed, but the preservation period differs depending on the content of the intermediate ingredient and the preservation method. Thus, the preservation period includes a period of how long the intermediate ingredient can be preserved by each of the preservation methods.

Accordingly, when the deciding unit 14 decides a sectioning position, the sectioning position is decided so that the period from the day on which the pre-preparation process is performed until the day on which the finishing process is performed does not exceed the preservation period. The period from the day on which the pre-preparation process is performed until the day on which the finishing process is performed is also referred to as “preservation request period”.

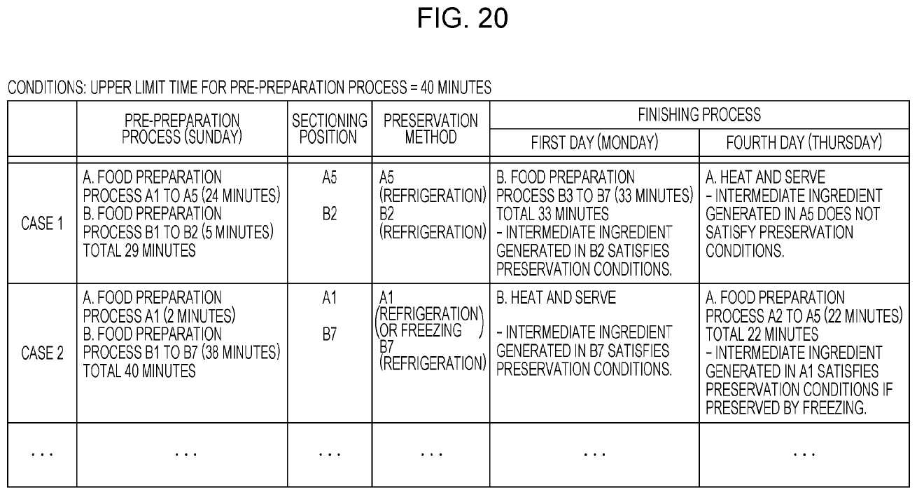

FIG. 20 is an explanatory diagram illustrating sectioning position deciding processing by the deciding unit 14 according to the present embodiment. FIG. 20 illustrates a case of sectioning position candidate deciding processing that the deciding unit 14 performs in step S204 in a case where conditions of “upper limit time for pre-preparation process=40 minutes” have been accepted as request information.

In a Case 1, the pre-preparation processes to be performed on Sunday include the food preparation processes A1 through A5 for cuisine A, and food preparation processes B1 and B2 for cuisine B, the necessary time for these being a total of 29 minutes. The finishing processes to be performed on Monday include food preparation processes B3 through B7 for cuisine B, the necessary time thereof being 33 minutes. The finishing process to be performed on Thursday also includes heating and serving of the cuisine A.

The sectioning positions in this case are as follows. The sectioning position for cuisine A is food preparation process A5, and for cuisine B is food preparation process B2. The preservation method of the intermediate ingredients for cuisine A is refrigeration preservation of the “fried patty” generated in food preparation process A5, and is preservation of the julienned cucumbers and ham generated in food preparation processes B1 and B2 for cuisine B.

Now, the preservation period by refrigeration preservation is three days for the intermediate ingredient “fried patty” generated in food preparation process A5, but the period over which this intermediate ingredient must be preserved is four days, and accordingly the preservation conditions are not satisfied. Accordingly, the deciding unit 14 does not take Case 1 as a candidate.

In a Case 2, the pre-preparation processes to be performed on Sunday include the food preparation process A1 for cuisine A and the food preparation processes B1 through B7 for cuisine B, the necessary time for these being a total of 40 minutes. The finishing processes to be performed on Monday include heating and serving of the cuisine B. The finishing process to be performed on Thursday includes food preparation processes A2 through A5 for cuisine A, the necessary time thereof being 22 minutes.

The sectioning positions in this case are as follows. The sectioning position for cuisine A is food preparation process A1, and for cuisine B is food preparation process B7. The preservation method of the intermediate ingredients for cuisine A is refrigeration preservation or freezing preservation of the “chopped onion” generated in food preparation process A1, and is preservation of the completed potato salad generated in food preparation process B7 for cuisine B.

Now, the preservation period of the intermediate ingredient “chopped onion” generated in food preparation process A1 is three days by refrigeration preservation, and is two weeks by freezing preservation. The preservation period of the completed potato salad generated in food preparation process B7 is three days, so both satisfy the preservation conditions. Accordingly, the deciding unit 14 decides on Case 2 as a candidate.

The deciding unit 14 acquires the preservation request periods calculated based on requests from the user, and decides the sectioning positions so that the preservation request periods do not exceed the preservation periods. Note that the deciding unit 14 can switch cuisines within the day that the user desires to perform the finishing process, and thereby increase candidates. This method will be described.

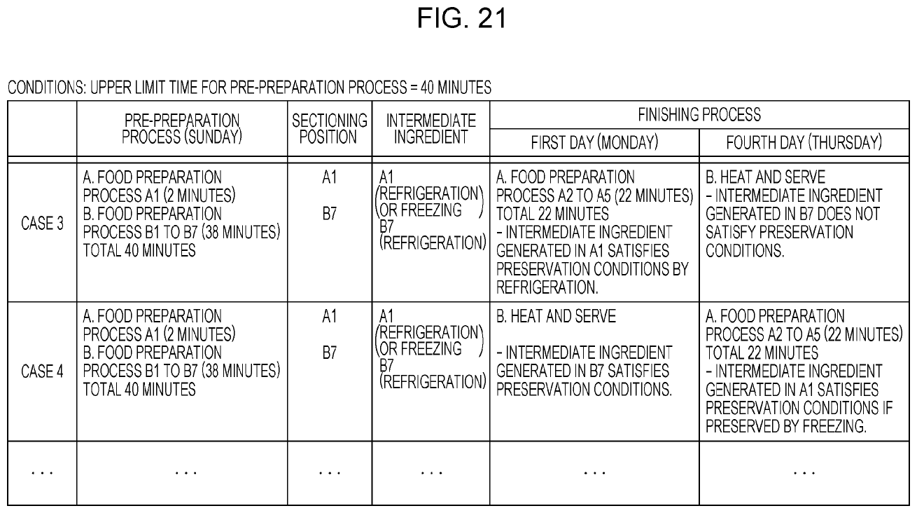

FIG. 21 is an explanatory diagram illustrating a second deciding method for sectioning positions by the deciding unit 14 according to the present embodiment. FIG. 21 illustrates a case of sectioning position candidate deciding processing that the deciding unit 14 performs in step S204 in a case where conditions of “upper limit time for pre-preparation process=40 minutes” have been accepted as request information.

In a Case 3, the pre-preparation processes to be performed on Sunday include the food preparation process A1 for cuisine A, and food preparation processes B1 through B7 for cuisine B, the necessary time for these being a total of 40 minutes. The finishing processes to be performed on Monday include food preparation processes A2 through A5 for cuisine A, the necessary time thereof being 22 minutes. The finishing process to be performed on Thursday also includes heating and serving of the cuisine B.

The sectioning positions in this case are as follows. The sectioning position for cuisine A is food preparation process A1, and for cuisine B is food preparation process B7. The preservation method of the intermediate ingredients for cuisine A is refrigeration preservation of the intermediate ingredient “chopped onion” generated in food preparation process A1, and is preservation of the completed potato salad generated in food preparation process B7.

Now, the preservation period by refrigeration preservation is three days for the completed potato salad generated in food preparation process B7, but the period over which the intermediate ingredient must be preserved is four days, so the preservation conditions are not satisfied. Accordingly, the deciding unit 14 does not take Case 3 as a candidate.

In this case, a Case 4 is generated by the deciding unit 14 switching the finishing process days in Case 3. In Case 4, the preservation period by refrigeration preservation is three days for the completed potato salad generated in food preparation process B7, while the preservation period by freezing preservation is two weeks for the “chipped onion” generated in the food preparation process A1, so the preservation conditions are satisfied. In this case, the deciding unit 14 decides on Case 4 as a candidate.

The deciding unit 14 increases the number of candidates by switching the day on which the finishing process is performed, taking into consideration preservation periods, and thus can flexibly decide sectioning positions. That is to say, when acquiring preservation request periods, a first point in time indicating a point in time for performing pre-preparation processes for all of multiple cuisines together, and a second point in time regarding each of the multiple cuisines, where the user individually performs finishing processes for each of the multiple cuisines, may be acquired. Periods having a time length from the first point in time to the second point in time for each of the multiple cuisines, are acquired as preservation request periods for each of the multiple cuisines. When deciding the sectioning positions, the deciding unit 14 switches the second points in time of the multiple cuisines, so that the preservation request period does not exceed the preservation period. Also note that when second points in time are switched, information may be output indicating that the second points in time have been switched.

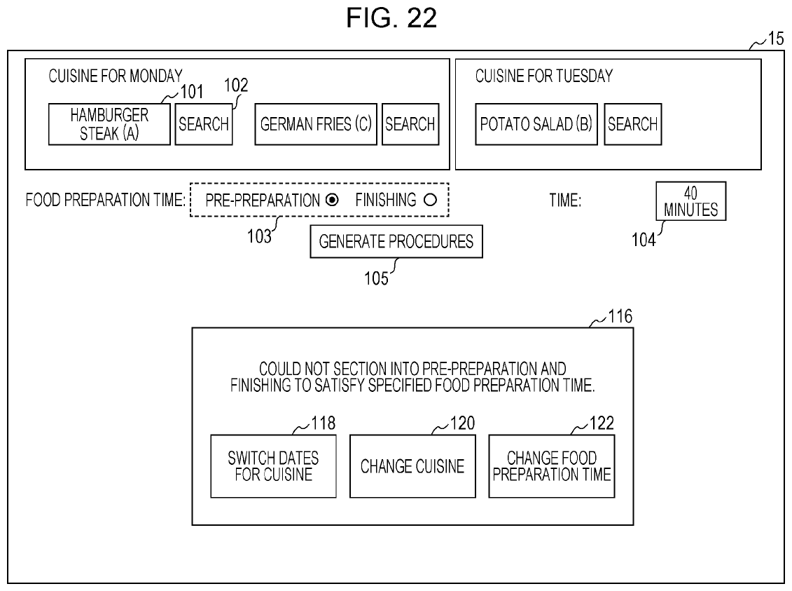

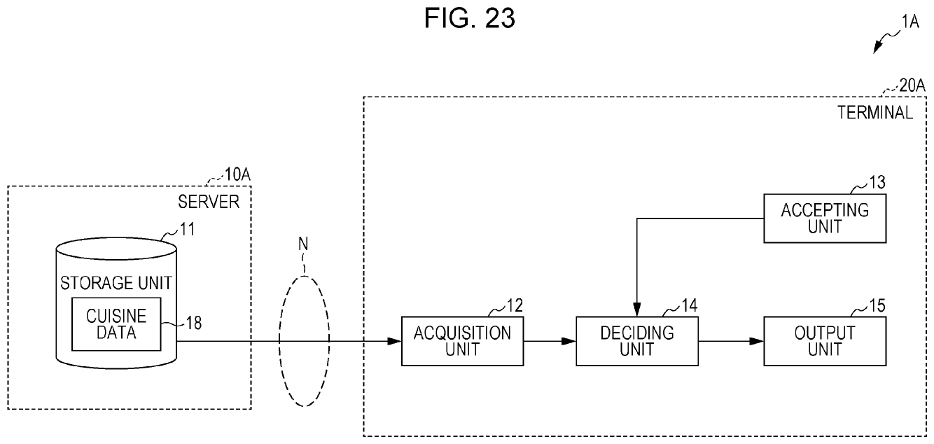

Next, an image showing notification to a user, which the information processing system 1 presents, will be described. FIG. 22 is an explanatory diagram illustrating a second example of an image (image 116) showing a notification made to the user, which the information processing system 1 according to the present embodiment presents. The image 116 is an example of an image presented when the deciding unit 14 cannot decide a sectioning position that will satisfy the requested time specified by the user. The image 116 includes buttons 118, 120, and 122, for accepting instructions regarding the processing that the information processing system 1 is to execute next.

The button 118 is a button for receiving instruction to switch the days in which the finishing processes of the cuisine are to be performed. When the button 118 is operated, the deciding unit 14 switches the days for the finishing processes as described above, and generates sectioning position candidates.

The button 120 is a button for receiving instructions for processing to change the cuisine to be prepared. When the button 120 is operated, the deciding unit 14 executes a cuisine search instruction (step S101, etc.) or the like, and receives an instruction regarding cuisine from the user.

The button 122 is a button for receiving change of food preparation time, i.e., change of request information. When the button 122 is operated, the deciding unit 14 executes reception of request information (step S202, etc.), and accepts requested time from the user.

According to the information processing method of the present embodiment described above, sectioning positions are decided so that periods over which intermediate ingredients are requested to be preserved (preservation request period) do not exceed preservation periods. The types of intermediate ingredients and preservation periods may change depending on where in the multiple food preparation processes the sectioning positions are set. Accordingly, when setting sectioning positions, setting the sectioning positions so that the preservation request periods do not exceed the preservation periods enables the intermediate ingredients to be preserved more appropriately, and the quality of the cuisine can be suppressed from deteriorating.

Also, sectioning positions can be decided so that the preservation request periods of intermediate ingredients do not exceed the preservation periods, including selecting appropriate preservation methods taking into consideration the preservation periods in cases of preserving by multiple preservation methods. Further, sectioning positions can be set to satisfy request information of the user, by switching cuisines among days that the user has specified as days to perform finishing process. Accordingly, in a case where the user's request information cannot be satisfied unless cuisines are switched, deterioration in the quality of the cuisine can be suppressed by switching the cuisines. The user can also be made to recognize that the cuisines have been switched.

### Modifications of the Embodiments

A modification of function sharing between the server 10 and terminal 20 in the above-described embodiments will be described. FIG. 23 is a block diagram illustrating the functional configuration of an information processing system 1A according to the present modification. The information processing system 1A includes a server 10A and terminal 20A, as illustrated in FIG. 23. The server 10A and terminal 20A are communicably connected by the network N. The server 10A has the storage unit 11. The terminal 20A has the acquisition unit 12, accepting unit 13, deciding unit 14, and output unit 15. The functional blocks that the server 10A and 20A have are the same as those in the embodiments above. In this case, exchange of information between the storage unit 11 and the acquisition unit 12 is performed via communication over the network N.

This configuration is advantageous as compared to the configuration in the above-described embodiments, in that the processing load on the server 10A can be reduced. The reason is that the processing of the deciding unit 14 and so forth can be handled by the terminal 20A. In a case where a great number of terminals 20A exists due to use by a great number of users, the advantage of reduced processing load of the server 10A is even greater.

In the above-described embodiments, the components may be configured as dedicated hardware; or may be realized by executing a software program suitable for each component. Each component may be realized by a program execution unit such as a CPU or other processor or the like reading out a software program recorded in a recording medium such as a hard disk, semiconductor memory, or the like, and executing the software program. Software that executes the information processing system according to the above-described embodiments is a program such as follows.

That is to say, this program causes a computer to execute, by using a processor: acquiring cuisine data for a cuisine that is prepared over a plurality of food preparation processes using a processor, the cuisine data including necessary time that is required for each of the plurality of food preparation processes; accepting request information for sectioning the plurality of food preparation processes into a pre-preparation process and a finishing process using the processor, the request information indicating a request for at least one of an amount of time that a user will take on the pre-preparation process and an amount of time that the user will take on the finishing process; deciding a sectioning position to section the plurality of food preparation processes into the pre-preparation process and the finishing process satisfying the request information using the processor, based on the necessary time included in the cuisine data; and displaying at least one of the pre-preparation process and the finishing process sectioned by the decided sectioning position on a display using the processor.

While an information processing system and so forth according to one or multiple aspects have been described by way of the above embodiment, the present disclosure is not restricted to the above embodiment. Various modifications to the embodiment and combinations of components of different embodiments which are conceivable by one skilled in the art may be encompassed by one or multiple aspects without departing from the essence of the present disclosure.

The present disclosure is applicable to an information processing system and so forth that suppresses deterioration in quality of cuisine, even in a case where time is limited for the user to execute food preparation processes.

What is claimed is:

1. An information processing method for rendering a processor able to determine a sectioning position for sectioning a cuisine preparation process after the processor is initially unable to determine the sectioning position for sectioning the cuisine preparation processes into a) a pre-preservation process comprising pre-preservation steps in which at least one ingredient is prepared and preserved using a predetermined preservation process that is no longer than its predetermined preservation period after which its quality deteriorates, and b) a finishing process comprising finishing steps performed no later than the end of the predetermined preservation period, because a time input into the processor for performing the finishing process is after the predetermined preservation period, the method comprising:
accepting a time at which the finishing process is to be performed with the processor;
displaying on a display a first screen displaying
a cuisine-name input space accepting the input of a cuisine name, which is then displayed in the cuisine-name input space;
a search button, which when selected, instructs the processor to search for preparation data for preparing the cuisine corresponding to the input cuisine name with a cuisine preparation process;
a time input space accepting the input of a time duration for one of the pre-preservation process and the finishing process of the cuisine preparation process;
pre-preparation and finishing buttons, only one of which is selectable at a time,
an accepting button, which when selected
causes the processor to section the cuisine preparation process into separately displayed pre-preservation steps and finishing steps displayed on a second screen, based on the input time duration for one of the pre-preservation process and the finishing process of the cuisine preparation process when the input time at which the finishing process is to be performed is no later than the end of the predetermined preservation period, and
renders the processor unable to section the cuisine preparation process into the separately displayed pre-preservation steps and finishing steps displayed on the second screen, based on the input time duration of the one of the pre-preservation process and the finishing process of the cuisine preparation process input in the time input space, when the accepted time at which the finishing process is to be performed is later than the end of the predetermined preservation period, and causes the display of a third screen; and
displaying the third screen, which displays an input area for receiving an instruction to switch the time at which the finishing process is to be performed, in response to the processor being rendered unable to section the cuisine preparation process into separately displayed pre-preservation steps and finishing steps after selection of the accepting button on the first screen when the input time at which the finishing process is to be performed is later than the end of the predetermined preservation period.

2. The information processing method according to claim 1,
wherein, the displaying of the second screen includes,
displaying the pre-preparation process and the finishing process in different display regions of the second screen of the display.

3. The information processing method according to claim 1,
wherein the time duration input by the time input space includes at least one of
a first upper limit time indicating an upper limit time for the pre-preparation process, and
a second upper limit time indicating an upper limit time for the finishing process, and
wherein the sectioning of the cuisine preparation process by the processor includes,
sectioning the cuisine preparation process where the time required for the pre-preparation process does not exceed the first upper limit time in a case where the input time duration input in the time input space indicates the first upper limit time, and
sectioning the cuisine preparation process where the time required for the finishing process does not exceed the second upper limit time in a case where the input time duration input in the time input space indicates the second upper limit time.

4. The information processing method according to claim 3,
wherein the cuisine-name input space is configured to accept a plurality of cuisine names, and when the cuisine-name input space accepts a plurality of cuisine names, selecting the search button causes searching for and acquiring of preparation data for the plurality of cuisines whose names were input into the cuisine-name input space,
wherein when preparation data for the plurality of cuisines is acquired, the time duration input by the time input space indicates at least one of the upper limit time for performing the pre-preparation process for all of the plurality of cuisines together, and a second upper limit time for individually performing the finishing process for each of the plurality of cuisines, and
wherein when the preparation data for the plurality of cuisines is acquired, the processor sections the cuisine preparation process for each of the plurality of cuisines.

5. The information processing method according to claim 1,
wherein the processor further sections the cuisine preparation process into a restoration process to restore an intermediate ingredient created in the pre-preservation process and preserved between the pre-preservation process and the finishing process
wherein when the processor further sections the cuisine preparation process into the restoration process, the second screen also displays information indicating the added restoration process on the display.

6. The information processing method according to claim 1, wherein when the processor is rendered unable to section the cuisine preparation process, the first screen displays information on the display to the effect that the cuisine preparation process is not able to be sectioned.

7. The information processing method according to claim 3, wherein where the time required for the pre-preparation process exceeds the input first upper limit time for the pre-preparation process, the processor
adds a predetermined amount of time to the pre-preparation process,
sections the cuisine preparation process into the pre-preservation process and the finishing process in accordance with the added predetermined amount of time, and
controls the display to display the pre-preservation steps and the finishing steps on the second screen according to the sectioning of the cuisine preparation process into the pre-preservation process and the finishing process performed by taking into account the added predetermined amount of time.

8. The information processing method according to claim 7, wherein the processor further controls the second screen of the display to display the added predetermined amount of time.

9. The information processing method according to claim 7,
wherein the processor controls the first screen to display an area accepting an input authorizing the adding of predetermined amount of time to the pre-preparation process and accepting an input preventing the adding of predetermined amount of time to the pre-preparation process, and
wherein the processor
sections the cuisine preparation process into the pre-preservation process and the finishing process in accordance with the added predetermined amount of time, and
controls the display to display the pre-preservation steps and the finishing steps on the second screen,
only when the adding of predetermined amount of time to the pre-preparation process is authorized in the accepting area accepting the authorizing and preventing inputs.

10. The information processing method according to claim 1, further comprising:
acquiring with the processor a preservation request period calculated based on a user request, wherein, the processor determining the sectioning position includes, determining the sectioning position where the processor sections the cuisine preparation process when the preservation request period does not exceed the predetermined preservation period.

11. The information processing method according to claim 10,
wherein, the predetermined preservation period includes a plurality of periods, each of which relates to a different preservation method.

12. The information processing method according to claim 10,
wherein the cuisine-name input space is configured to accept a plurality of cuisine names,
wherein when the cuisine-name input space accepts a plurality of cuisine names, selecting the search button causes searching for and acquiring of preparation data for the plurality of cuisines whose names were input into the cuisine-name input space, and the acquiring of a preservation request period,
wherein the acquiring of the preservation request period includes
acquiring (i) a first point in time for performing pre-preservation processes for the plurality of cuisines together, and (ii) a second point in time for each of the multiple cuisines, where the finishing processes for each of the plurality of cuisines are individually performed, and
acquiring a period from the first point in time to the second point in time for each of the plurality of cuisines, as the preservation request period for each of the plurality of cuisines, and
wherein the method further comprises switching the second points in time of the plurality of cuisines when the preservation request period does not exceed the predetermined preservation period.

13. The information processing method according to claim 12, further comprising:
generating information indicating that the second points in time for regarding the plurality of cuisines have been switched with each other,
displaying on the display the information indicating that the second points in time have been switched with each other.

14. A system for rendering a processor able to determine a sectioning position for sectioning a cuisine preparation process after the processor is initially unable to determine the sectioning position for sectioning the cuisine preparation processes into a) a pre-preservation process comprising pre-preservation steps in which at least one ingredient is prepared and preserved using a predetermined preservation process that is no longer than its predetermined preservation period after which its quality deteriorates, and b) a finishing process comprising finishing steps performed no later than the end of the predetermined preservation period, because a time input into the processor for performing the finishing process is after the predetermined preservation period, comprising:
a display;
an accepting unit configured to accept a time at which the finishing process is to be performed;
a processor, determining the sectioning position, controlling the display, and receiving an input from the accepting unit for the time for performing the finishing process; and
a memory storing thereon a computer program, which when executed by the processor, causes the processor to control the display to perform operations including
i) displaying a first screen displaying
a cuisine-name input space accepting the input of a cuisine name, which is then displayed in the cuisine-name input space,
a search button, which when selected, instructs the processor to search for preparation data for preparing the cuisine corresponding to the input cuisine name with a cuisine preparation process,
a time input space accepting the input of a time duration for one of the pre-preparation process and the finishing process of the cuisine preparation process,
pre-preparation and finishing buttons, only one of which is selectable at a time,
an accepting button, which when selected
causes the processor to section the cuisine preparation process into separately displayed pre-preservation steps and finishing steps displayed on a second screen, based on the input time duration for one of the pre-preparation process and the finishing process of the cuisine preparation process when the input time at which the finishing process is to be performed is no later than the end of the predetermined preservation period, and
renders the processor unable to section the cuisine preparation process into separately displayed pre-preservation steps and finishing steps displayed on the second screen, based on the input time duration of the one of the pre-preparation process and the finishing process of the cuisine preparation process input in the time input space, when the time at which the finishing process is to be performed that is input into the accepting unit is later than the end of the predetermined preservation period, and causes the display of a third screen,
ii) displaying the third screen, which displays an input area for receiving an instruction to switch the time at which the finishing process is to be performed, in response to the processor being rendered unable to section the cuisine preparation process into separately displayed pre-preservation steps and finishing steps after selection of the accepting button on the first screen when the input time at which the finishing process is to be performed is later than the end of the predetermined preservation period.
